(19) United States
(12) Patent Application Publication
(10) Pub. No.: US 2019/0373017 A1
(43) Pub. Date: Dec. 5, 2019

(54) APPARATUS FOR PROVIDING TRAINING PROGRAM AGAINST CYBER THREAT

(71) Applicant: AGENCY FOR DEFENSE DEVELOPMENT, Daejeon (KR)

(72) Inventors: Donghwan LEE, Daejeon (KR); Donghwa KIM, Daejeon (KR); Yonghyun KIM, Daejeon (KR)

(73) Assignee: AGENCY FOR DEFENSE DEVELOPMENT, Daejeon (KR)

(21) Appl. No.: 16/240,849

(22) Filed: Jan. 7, 2019

(30) Foreign Application Priority Data
Jun. 5, 2018 (KR) 10-2018-0065046

(51) Int. Cl. H04L 29/06; G09B 9/00

(52) U.S. Cl. CPC H04L 63/1466; G09B 9/00; H04L 63/1433; H04L 63/1416

(57) ABSTRACT

The present invention relates to an apparatus for providing a training program against various cyber threats for protecting information under a cyber environment, and the apparatus includes a constructive training unit to provide a constructive model based cyber training program, a live-virtual training unit to provide a live-virtual model based cyber training program, and a model conversion unit to extract at least one threat packet to be converted and information related to the at least one threat packet from the constructive model, based on a threat field included in the constructive model, convert the constructive model into a live-virtual model using the extracted information related to the at least one threat packet, and transmit the converted live-virtual model to the live-virtual training unit.

### CROSS-REFERENCE TO RELATED APPLICATION

Pursuant to 35 U.S.C. § 119(a), this application claims the benefit of earlier filing date and right of priority to Korean Application No. 10-2018-0065046, filed on Jun. 5, 2018, the contents of which are incorporated by reference herein in their entirety.

### TECHNICAL FIELD

The present invention relates to an apparatus for providing a training program against various cyber threats for protecting information under a cyber environment.

### BACKGROUND ART

With development of communication technologies, the need for information protection against various cyber threats in cyber information systems and on information networks is increasing. Accordingly, there is a growing demand for excellent information security personnel capable of dealing with various cyber threats. The training of excellent information protection personnel is a goal that is difficult to be achieved merely by simple theory education, and actual training programs or training programs similar to such actual programs are essential. Recently, in military and civilian areas, various information protection training schemes, namely, training programs against cyber threats have been actively developed.

There are two types of training programs against cyber threats. Such training programs may be divided into a first type which is a constructive model based cyber training program for simulating and training cyber warfare, from the macro perspective, mainly through a battle experimentation, and a second type which is a live-virtual model based cyber training program for training defensive actions against detailed cyber treats through a virtual environment almost identical to a real environment.

In the constructive model based cyber training program, generic traffic (or general traffic) and threat traffic distributed on a real information network are not distributed, but event-based simulated generic traffic and simulated threat traffic are distributed instead. On the other hand, in the live-virtual model based cyber training program, distribution of generic traffic and threat traffic distributed on a real information network is made under a virtual environment.

This difference lowers compatibility between the two programs in the related art, and studies for improving compatibility are still in early stages. Currently, only generic traffic can be distributed in a limited manner. Therefore, a concrete methodology for sharing threat traffic between both programs is required.

### DETAILED DESCRIPTION OF THE DISCLOSURE

One aspect of the present invention is to improve compatibility between a constructive model based cyber training program and a live-virtual virtual model-based cyber training program.

Another aspect of the present invention is to provide a training program capable of providing various types of cyber warfare to deal with cyber threats.

To achieve the aspects and other advantages according to the present invention, there is provided an apparatus for providing a training program against cyber threats according to the present invention, the apparatus including a constructive training unit to provide a constructive model based cyber training program, a live-virtual training unit to provide a live-virtual model based cyber training program, and a model conversion unit to extract at least one threat packet to be converted and information related to the at least one threat packet from the constructive model, based on a threat field included in the constructive model, convert the constructive model into a live-virtual model using the extracted information related to the at least one threat packet, and transmit the converted live-virtual model to the live-virtual training unit.

In one embodiment, the model conversion unit may include a packet detector to detect at least one simulation packet to be converted from the constructive model, a threat detector to classify the detected at least one threat packet into one of a generic packet and a threat packet based on a threat field included in the detected at least one simulation packet, a threat packet generator to convert the threat packet into a real threat packet used in the live-virtual model based on an event field of the threat packet classified by the threat detector, and a real packet transmitter to transmit the converted real threat packet to the live-virtual training unit.

In one embodiment, the model conversion unit may further include a packet database to store a real packet model for the conversion into the live-virtual model for each of the at least one threat packet included in the constructive model, and the threat packet generator may search for information related to a real threat packet corresponding to the threat packet classified by the threat detector from the packet database, and convert the threat packet classified by the threat detector into a real threat packet using the search result.

In one embodiment, the threat packet generator may transmit the converted real threat packet to the live-virtual training unit.

In one embodiment, the live-virtual training unit may generate the live-virtual model based cyber training program based on the live-virtual model transmitted from the model conversion unit.

### Effects of the Disclosure

The present invention can expand training scenarios by converting a constructive model based cyber training program into a live-virtual model based training system.

Further, the present invention can improve an effect of training against cyber warfare owing to an expansion of training scenarios.

In addition, when it is difficult to know an effect of a cyber threat in an actual cyber battlefield only by a constructive model based cyber training program, similar results to those in the actual cyber battlefield can be acquired by converting the constructive model based cyber training program into a live-virtual model based cyber training program, thereby enhancing effects of simulations and tests on cyber warfare.

### BRIEF DESCRIPTION OF THE DRAWINGS

FIG. 1 is a block diagram illustrating components of an apparatus for providing a training program against cyber threats in accordance with the present invention.

FIG. 2 is a block diagram illustrating a configuration of a model conversion unit of a training program providing apparatus to deal with cyber threats in accordance with the present invention.

FIG. 3 is a flowchart illustrating a method in which the model conversion unit of FIG. 2 converts a constructive model into a live-virtual model.

### BEST MODE FOR CARRYING OUT THE PREFERRED EMBODIMENTS

Hereinafter, description will be given in detail embodiments of the present disclosure with reference to the accompanying drawings so that those skilled in the art can easily carry out the present disclosure. However, the present disclosure is not limited to the following embodiments, but merely serves as means for effective explanation to a person skilled in the art to which the present disclosure belongs.

In describing the present disclosure, if a detailed explanation for a related known technology is considered to unnecessarily divert the gist of the present disclosure, such explanation has been omitted. For the sake of brief description with reference to the drawings, the same or equivalent components may be provided with the same or similar reference numbers.

It will be understood throughout the specification that when an element is referred to as being “connected with” another element, it includes not only a case of “being directly connected with” but also “being electrically connected with” each other with intervening elements therebetween. Also, when a section is referred to as “including” an element, it is understood that other elements are not excluded but further included, unless specifically stated otherwise.

Herein, the term ‘unit’ or module includes a unit realized by hardware or software, and a unit realized by using both. Also, one unit may be realized by two or more hardware or two or more units may be realized by one hardware.

The terms to be explained herein are defined in consideration of functions of the present disclosure, and may be changed according to a user, intention of an operator, custom, or the like. Therefore, the definition should be made based on the contents throughout this specification.

In order to protect important military information on a battlefield along with development of information and communication technologies, the need for specialized personnel to cope with cyber threats such as hacking is increasing. In order to train such specialized personnel, it is necessary to develop training programs providing simulated threat scenarios similar to actual cyber threats.

The related art training program providing apparatuses provide one of a constructive model based training program of creating an artificial environment such as a battle experimentation or a live-virtual model based training program of creating a virtual environment similar to an actual one.

The training program may simulate types of attacks that actually occur in cyber threats. For example, cyber threats may be Distributed Denial of Service (DDoS), Advanced Persistent Threat (APT), Stuxnet, and so on.

Distributed Denial of Service (DDoS) is also known as ‘DDos attack’, and is a hacking attack that service attack tools are put in multiple computers and tremendous packets that a computer system of a site to be attacked is incapable to handle are flooded simultaneously, to deteriorate network performance or paralyze the system.

Advanced Persistent Threat (APT) is a type of hacking attack that an attacker sends an email with malware attached to users to make the users open the email so that the users' PCs are infected into zombie PCs, and the infected zombie PCs increase to destroy a server such that malicious codes hidden in an inner system steal database information.

Stuxnet is a computer virus designed to destroy infrastructure facilities such as power stations, airports, railways, etc. It is a sophisticated computer worm whose operation principle has not been fully examined and that accesses a secret server to update by itself. The computer worm infiltrates when employees connect virus-infected USB storage devices or MP3 players to their office computers.

On the other hand, in the related art training program providing apparatus, it has been difficult to convert a constructive model based training program into a live-virtual model based training program. Accordingly, the present invention desires to propose a method of converting the constructive model based training program into the live-virtual model based training program.

FIG. 1 is a block diagram illustrating components of an apparatus for providing a training program against cyber threats in accordance with the present invention.

An apparatus for providing a training program (i.e., a training program providing apparatus) according to the present invention may include a constructive training unit 100, a live-virtual training unit 200, a model conversion unit 300, and a control unit 400.

The constructive training unit 100 may generate a constructive model based training program. The constructive model is a model simulating an artificial cyber-warfare environment, such as a battle experimentation. Accordingly, the constructive training unit 100 may provide a specific cyber warfare situation to a defender (a trainee) without an actual attacker, so that the defender can perform training. The constructive model may be configured to provide training scenarios for each event unit classified according to various attack types of cyber threats.

The live-virtual training unit 200 may generate a training program based on a live-virtual model. The live-virtual model may provide an environment similar to a real cyber battlefield. An attack terminal performing a cyber attack and a defending terminal defending a cyber attack may perform training in preparation for cyber warfare under the environment provided by the live-virtual model.

The model conversion unit 300 may convert a constructive model based training program received from the constructive training unit 100 into a live-virtual model based training program.

The control unit 400 may control the constructive model training unit, the live-virtual training unit, and the model conversion unit. For example, the control unit 400 may control the constructive training unit 100 or the live-virtual training unit 200 to provide one of the constructive model based training program or the live-virtual model based training program. Alternatively, the control unit 400 may control the model conversion unit 300 to convert the constructive model based training program generated by the constructive training unit into the live-virtual model based training program.

In the foregoing, the training program providing apparatus that provides the training program against a cyber threat has been described.

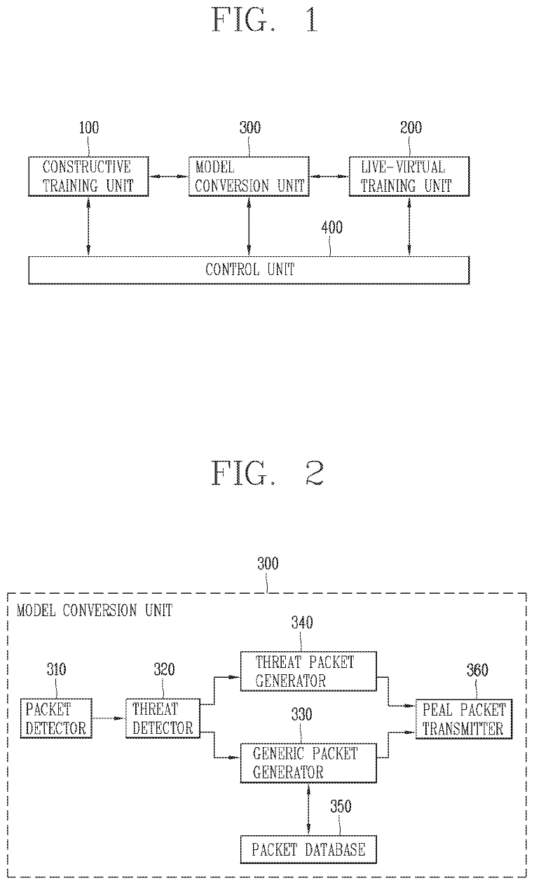

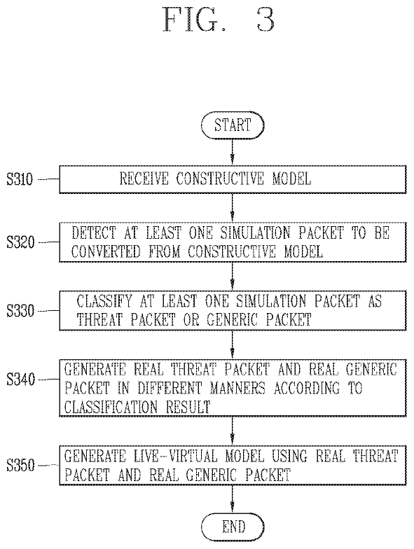

Hereinafter, description will be given in more detail of a method in which a training program providing apparatus according to the present invention converts a constructive model into a live-virtual model. FIG. 2 is a block diagram illustrating a configuration of a model conversion unit of a training program providing apparatus to deal with cyber threats in accordance with the present invention.

Referring to FIG. 2, the model conversion unit 300 of the training program providing apparatus according to the present invention includes a packet detector 310, a threat detector 320, a threat packet generator 330, a generic packet generator 340, a packet database 350, and a live-packet transmitter 350.

First, the packet detector 310 may receive every simulation packet generated in a constructive model from the constructive training unit 100. Here, the packet is a component of traffic on a network. A flow of such a plurality of packets may constitute the traffic.

The packet detector 310 may detect at least one simulation packet to be converted among the simulation packets received from the constructive training unit 100. The simulation packet to be converted is a packet preset to be converted when converting the constructive model into the live-virtual model. This information may be prestored in a memory.

The threat detector 320 may receive the simulation packet to be converted and information related to the simulation packet from the packet detector 310. That is, the threat detector 320 may receive the detected at least one simulation packet. The information related to the detected at least one simulation packet may include a threat field. The threat field may include a name of a threat and threat-related parameter information.

The threat detector 320 may classify the detected at least one simulation packet into a generic packet or a threat packet based on the threat field of the detected at least one simulation packet. For example, the threat detector 320 may identify a threat name included in the threat field for each simulation packet. The threat detector 320 may classify the simulation packet as a threat packet if the threat name is a prestored threat name, and on the other hand, classify the simulation packet as a generic packet if not.

The threat detector 320 may transmit the classified simulation packet to one of the threat packet generator 330 and the generic packet generator 340.

The threat packet generator 330 may receive the simulation packet classified as the threat packet from the threat detector 320. The threat packet generator 330 may convert the simulation packet classified as the threat packet into a real threat packet usable in the live-virtual model based on an event field of the simulation packet classified as the threat packet. The event field may include a threat name and threat packet-related parameters.

More specifically, the threat packet generator 330 may detect the threat name of the simulation packet from the event field of the simulation packet. Information for generating a real threat packet corresponding to the detected threat name may be searched for from the packet database 350. Accordingly, the threat packet generator 330 may convert the simulation packet into a real threat packet using the searched information for the real threat packet. The threat packet generator 330 may transmit the converted real threat packet to the real packet transmitter 360.

Information for generating real threat packets may be prestored for each threat name in the packet database 350. The information for generating the real threat packets may include a threat payload.

The generic packet generator 340 may receive a simulation packet classified as a generic packet from the threat detector 320. The generic packet generator 340 may convert the simulation packet classified as the generic packet into a real generic packet. More specifically, the generic packet generator 340 may convert a simulation packet into a real generic packet based on an event field of the simulation packet. Here, the event field may include information such as a protocol type, a destination IP address, and the like. The generic packet generator 340 may transmit the converted real generic packet to the real packet transmitter 360.

The real packet transmitter 360 may generate a live-virtual model in cooperation with the live-virtual training unit 200. Specifically, the real packet transmitter 360 may receive a real threat packet generated in the threat packet generator 330 and a real generic packet generated in the generic packet generator 340. The real packet transmitter 360 may transmit the received real threat packet and real generic packet to the live-virtual training unit 200 so that the live-virtual model is generated.

The live-virtual training unit 200 may generate the live-virtual model using the received real threat packet and real generic packet. With this configuration, the present invention can convert the constructive model based training program into the live-virtual based training program.

The foregoing description has been given of the components of the training program providing apparatus in preparation for the cyber threat according to the present invention.

Hereinafter, a control method for converting a constructive model based training program into a live-virtual model based training program in a training program providing apparatus in preparation for a cyber threat according to the present invention will be described in more detail. FIG. 3 is a flowchart illustrating a method in which the model conversion unit of FIG. 2 converts a constructive model into a live-virtual model.

Referring to FIG. 3, the packet detector 310 of the model conversion unit 300 may receive a constructive model from the constructive training unit 100 (S310). Then, the packet detector 310 may detect at least one simulation packet to be converted from the constructive model received from the constructive training unit 100 (S320). The packet detector 310 may extract at least one simulation packet to be converted into a live-virtual model among all the simulation packets. The packet detector 310 may transmit the extracted at least one packet to the threat detector 320.

The threat detector 320 may classify the detected at least one simulation packet into a threat packet or a generic packet (S330).

The threat detector 320 may classify the extracted at least one packet into a threat packet or a generic packet based on a threat field of the extracted at least one packet. For example, if a threat name is included in the threat field, such packet may be classified as a threat packet. Otherwise, the packet may be classified as a generic packet.

The classified threat packet and generic packet may be generated as a real threat packet and a real generic packet in different manners (S340).

The threat detector 320 may transmit the classified threat packet to the threat packet generator 330 so that the classified threat packet is converted into a real threat packet. The threat packet generator 330 may convert the threat packet into a real threat packet based on an event field of the classified threat packet. A detailed description thereof will be replaced with the description of FIG. 2.

Similarly, the threat detector 320 may transmit the classified generic packet to the generic packet generator 340 so that the classified generic packet is converted into a real generic packet. The generic packet generator 340 may convert the classified generic packet into a real generic packet based on an event field of the classified generic packet. A detailed description thereof will be replaced with the description of FIG. 2.

The real packet transmitter 360 may generate a live-virtual model using the real threat packet and the real generic packet (S340). The real packet transmitter 360 may serve as a path between the live-virtual training unit 200 and the model conversion unit 300. The real packet transmitter 360 may transmit the real threat packet and the real generic packet to the live-virtual training unit 200 and the live-virtual training unit 200 may generate a live-virtual model based training program using the transmitted packets.

The present invention can expand training scenarios by converting a constructive model based cyber training program into a live-virtual model based cyber training system.

Further, the present invention can improve an effect of training against cyber warfare owing to the expansion of the training scenarios.

In addition, when it is difficult to know an effect of a cyber threat in an actual cyber battlefield only by the constructive model based cyber training program, similar results to those in the actual cyber battlefield can be acquired by converting the constructive model based cyber training program into the live-virtual model based cyber training program, thereby enhancing effects of simulations and tests on cyber warfare.

The scope of the present invention is defined by the appended claims rather than the detailed description, and all changes or modifications derived from the meaning and scope of the claims and their equivalents are to be construed as being included within the scope of the present invention.

1. An apparatus for providing a training program against a cyber threat, the apparatus comprising:
a constructive training unit to provide a constructive model based cyber training program;
a live-virtual training unit to provide a live-virtual model based cyber training program; and
a model conversion unit to:
extract at least one threat packet to be converted and information related to the at least one threat packet from the constructive model, based on a threat field included in the constructive model,
convert the constructive model into the live-virtual model using the extracted information related to the at least one threat packet, and
transmit the converted live-virtual model to the live-virtual training unit.

2. The apparatus of claim 1, wherein the model conversion unit comprises:
a packet detector to detect at least one simulation packet to be converted from the constructive model;
a threat detector to classify the detected at least one threat packet into one of a generic packet and a threat packet based on a threat field included in the detected at least one simulation packet;
a threat packet generator to convert the threat packet into a real threat packet used in the live-virtual model based on an event field of the threat packet classified by the threat detector; and
a real packet transmitter to transmit the converted real threat packet to the live-virtual training unit.

3. The apparatus of claim 2, wherein the model conversion unit further comprises:
a packet database to store a real packet model for the conversion into the live-virtual model for each of the at least one threat packet included in the constructive model, and
wherein the threat packet generator searches for information related to a real threat packet corresponding to the threat packet classified by the threat detector from the packet database, and converts the threat packet classified by the threat detector into the real threat packet using the search result.

4. The apparatus of claim 2, wherein the threat packet generator transmits the converted real threat packet to the live-virtual training unit.

5. The apparatus of claim 1, wherein the live-virtual training unit generates the live-virtual model based cyber training program based on the live-virtual model transmitted from the model conversion unit.
